(19) United States
(12) Patent Application Publication
(10) Pub. No.: US 2014/0070650 A1
(43) Pub. Date: Mar. 13, 2014

(54) Electric Motor Turbine

(71) Applicant: Chris Brantley, Loveland, CO (US)

(72) Inventor: Chris Brantley, Loveland, CO (US)

(21) Appl. No.: 14/020,964

(22) Filed: Sep. 9, 2013

Related U.S. Application Data
(60) Provisional application No. 61/699,463, filed on Sep. 11, 2012.

(51) Int. Cl. H02K 47/20

(52) U.S. Cl. CPC H02K 47/20; H02K 53/00
USPC 310/113; 74/DIG. 9

(57) ABSTRACT

An electric motor turbine apparatus for generating additional electricity is disclosed. The apparatus comprises an electric turbine that spins a magnet within a suspended stationary ring magnet. An electric current is induced in a conductor element attached to the stationary ring magnet and located at least partially between the stationary ring magnet and the spinning magnet.

### CROSS-REFERENCE

This application claims priority from Provisional Patent Application Ser. No. 61/699,463 filed Sep. 11, 2012.

### FIELD OF THE INVENTION

This invention pertains generally to an apparatus for generating electricity, and more particularly to an apparatus using an electrically driven turbine to induce additional electrical current from a rotating magnetic field.

### BACKGROUND

Electricity is widely used as a primary power source for operating a wide variety of motors. Typically, fossil fuels are converted into electricity at electric power plants, which is then delivered throughout the world via existing electrical grids. Traditional fuels used to generate this electricity include coal, oil, and nuclear fuels which can be extremely hazardous to the environment. Although there are alternative cleaner energy sources useable to generate electricity such as wind, water, and solar power, the vast majority of electrical energy is generated from these traditional fuels. These fuels tend to be expensive and contribute heavily to the existing pollution problem. Additionally, without conservation, these resources will either run out or become cost prohibitive to use in the near future.

Consequently, there exists a need for a supply of a non-fossil fuel based electrical energy source that can satisfy the ever expanding demand for electrical energy with significantly less environmental consequences. The present invention discloses an apparatus that uses a small amount of traditionally produced electricity to create additional electricity by magnetic induction without creating additional pollution. The apparatus uses magnets to create electrical current that is collected and distributed via a conductor. Furthermore, the invention decreases the amount of fossil fuel needed to produce electricity

### SUMMARY

The following presents a simplified summary in order to provide a basic understanding of some aspects of the disclosed invention. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one aspect thereof, comprises an apparatus for producing an electrical current by magnetic induction. The apparatus comprises an electric motor turbine for spinning a rotating magnet situated within a housing. The apparatus further comprises a stationary ring magnet suspended from the housing around the rotating magnet. As the electric turbine spins the rotating magnet, an electric charge is induced and collected by a conductor element attached to an inner wall of the stationary ring magnet. The induced electricity is transmitted through the conductor element for use in powering an electric motor.

Furthermore, in a preferred embodiment of the invention, the rotating magnet is a positively charged cylindrical magnet connected to the electric motor turbine via a drive shaft. The stationary ring magnet is negatively charged. The conductor element may comprise a plurality of conductors which are wire coils for collecting the induced electricity. The first ends of the wire coils are attached to the inner wall of the stationary ring magnet. As such, the first ends are located between the rotating magnet and the stationary magnet. The second ends of the wire coils come together to form an electrical output for transmitting the induced electricity to an end user. The electrical output is attached to the housing and holds the suspended stationary ring magnet in place around the rotating magnet.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a perspective view of an apparatus for producing an electric current in accordance with the disclosed architecture.

FIG. 2 illustrates a lower half cut away view of the apparatus in accordance with the disclosed architecture.

FIG. 3 illustrates an upper half cut away view of the apparatus in accordance with the disclosed architecture.

FIG. 4 illustrates a perspective view an internal structure of the apparatus in accordance with the disclosed architecture.

### DETAILED DESCRIPTION

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter. The invention relates generally to an apparatus for generating electricity using a rotating magnetic field. The apparatus uses a small amount of electricity to rotate a magnet within an oppositely charged magnetic field and collect the additional induced electricity for later use.

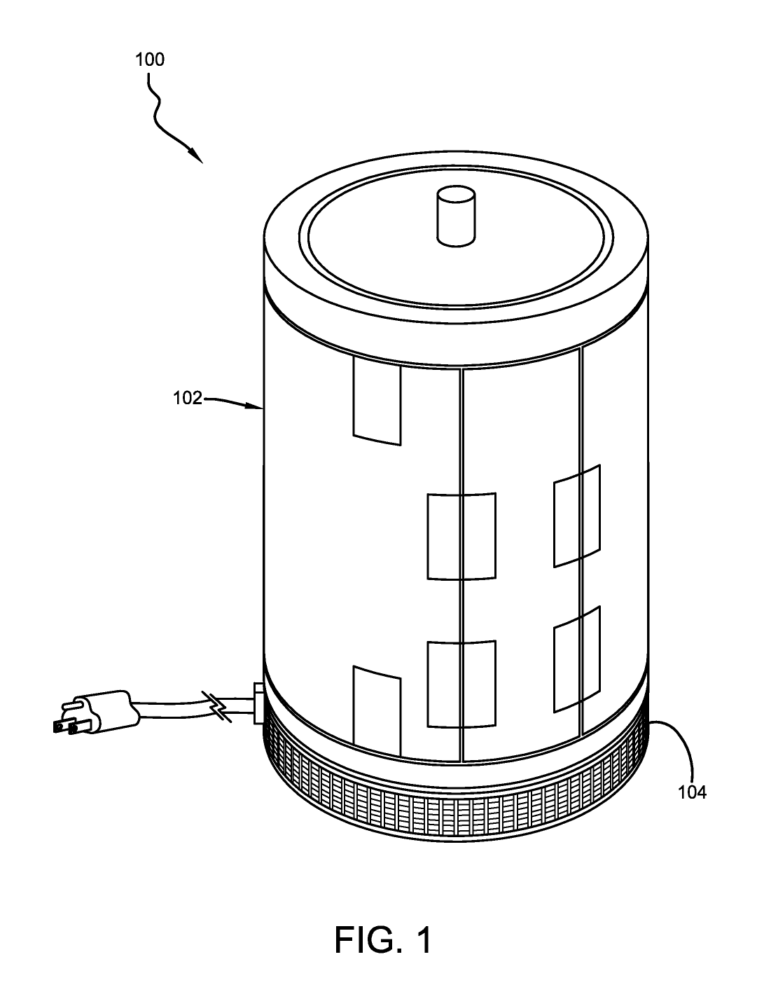

Referring initially to the drawings, FIGS. 1-4 illustrate an apparatus 100 for generating an electric current. The apparatus 100 comprises a housing 102, an electric motor turbine 104 and a rotating magnet 110. The housing 102 is typically a rigid substantially hollow cylindrical non-conductive covering for surrounding the rest of the apparatus 100. In a preferred embodiment, the housing 102 may be approximately ten feet in height and approximately six feet in diameter. However, the housing 102 may be smaller or larger in dimension as desired depending on the amount of electricity to be generated, such as an embodiment sized to power a single household appliance for example.

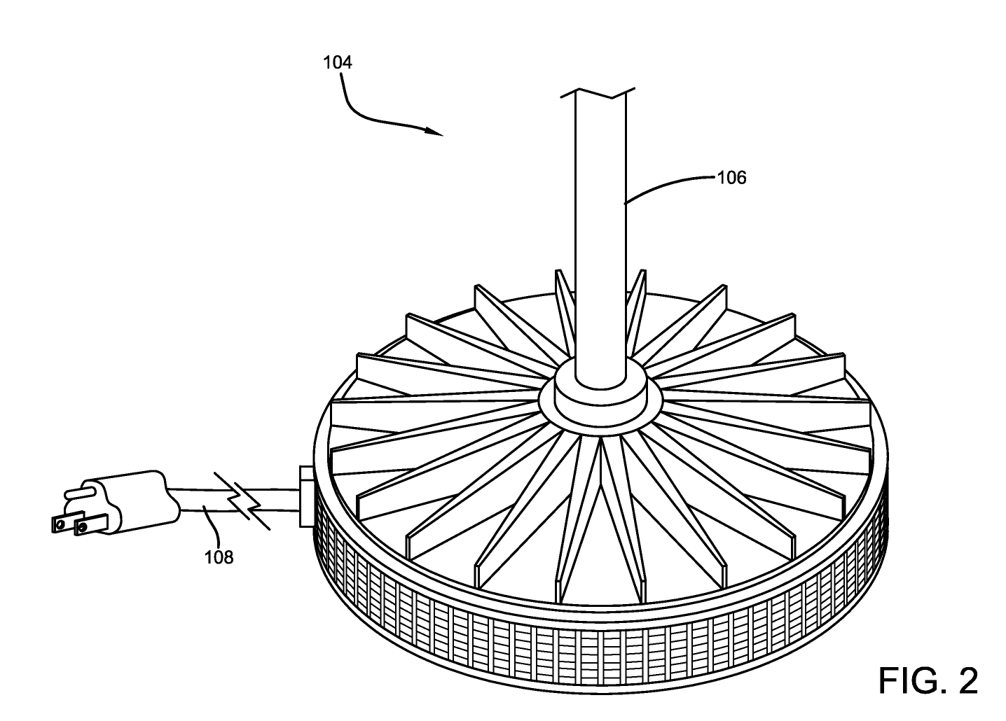

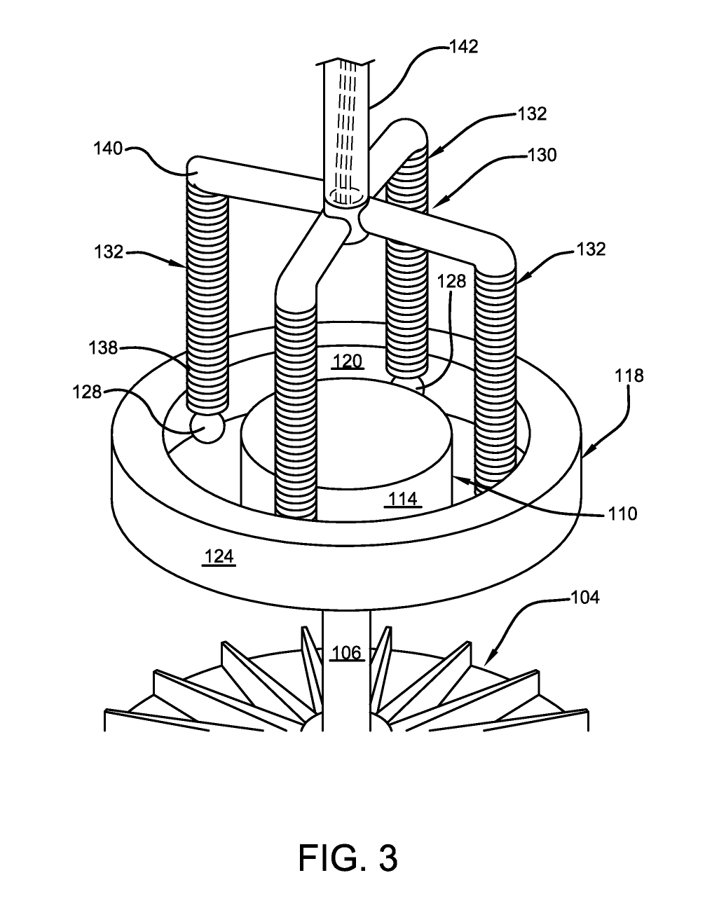

As illustrated in FIGS. 2-3, the electric motor turbine 104 is substantially located within the housing 102 forming a base for the apparatus 100. The electrical motor turbine 104 is essentially a prior art turbine driven by an electric motor. The electric motor turbine 104 comprises a driveshaft 106 and an electrical input 108. The electrical input 108 is typically a standard wire and plug capable of conducting sufficient electricity to power the electric motor turbine 104. The driveshaft 106 extends upward into the housing 102 and terminates in the rotating magnet 110.

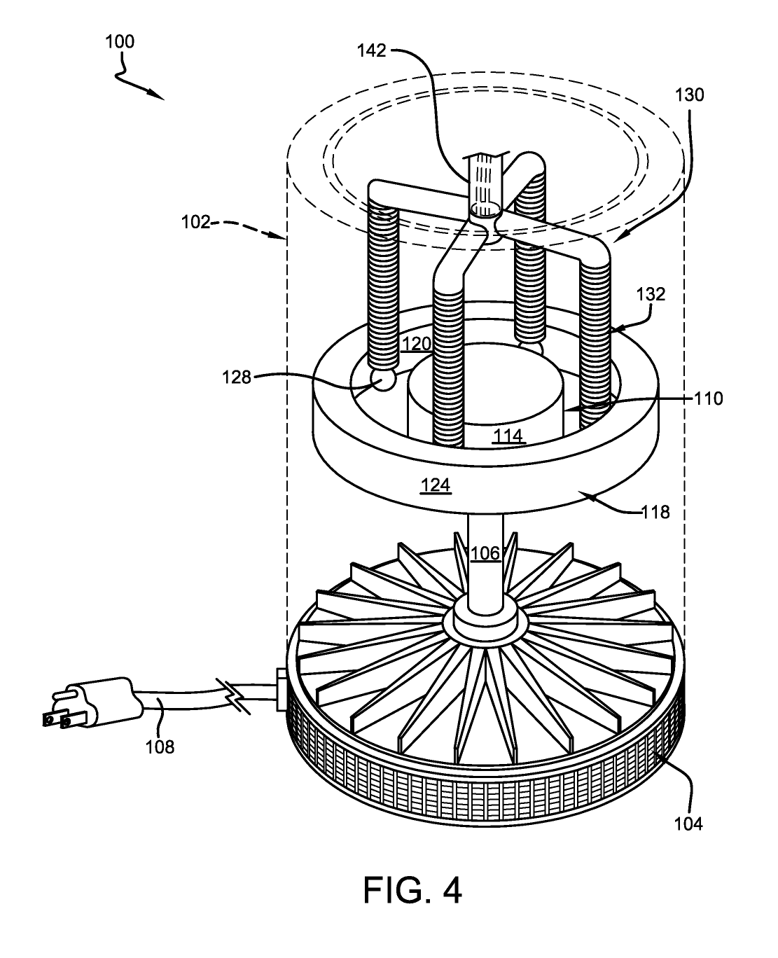

As illustrated in FIGS. 3-4. the rotating magnet 110 is attached to, and is spun by the driveshaft 106 as it is rotated by the electric motor turbine 104. The rotating magnet 110 is typically a cylindrical magnet with a positive charge that comprises an outer wall 114. However, the inventor contemplates an embodiment where the rotating magnet 110 is negatively charged as well as described infra. Typically, the electric motor turbine 104 spins the rotating magnet 110 in a clockwise direction, although the direction of spin may be counterclockwise and still generate the electric current.

The apparatus 100 further comprises a stationary magnet 118 that essentially surrounds, but is not attached to, the rotating magnet 110. The stationary magnet 118 is typically a ring magnet with a negative charge. However, the stationary magnet 118 may be positively charged in an embodiment where the rotating magnet 110 has a negative charge. The stationary magnet 118 comprises an inner circumference wall 120 and an outer circumference wall 124. The stationary magnet 118 is suspended around the rotating magnet 110 so that the inner circumference wall 120 of the stationary magnet 118 is in line with or essentially parallel to the outer wall 114 of the rotating magnet 110. In other words, the stationary magnet 118 basically encircles the rotating magnet 110. Preferably, a distance between the inner circumference wall 120 of the stationary magnet 118 and the outer wall 114 of the rotating magnet 110 is approximately between 20 and 30 percent of the rotating magnet's diameter.

The apparatus 100 further comprises a conductor element 130. The conductor element 130 comprises a plurality of conductors 132 and an electrical output 142. The conductor element 130 is attached to and extends out of a top of the housing 102. The conductor element 130 is also attached to the stationary magnet 118, thereby suspending it around the rotating magnet 110. The conductor element collects the current induced by the rotating magnet 110 spinning within the stationary magnet 118, and transmits the electricity out of the apparatus 100 for use elsewhere. The distance between the inner circumference wall 120 of the stationary magnet 118 and the outer wall 114 of the rotating magnet 110 discussed supra is preferable as it allows for the electric current to be better receptive to the plurality of conductors 132.

The plurality of conductors 132 are typically wire coils of a conductive metal such as copper, silver, aluminum, or the like. The plurality of conductors 132 collect the induced electricity transmitting it to the electrical outlet 142. Each of the plurality of conductors 132 comprises a first end 138 and a second end 140. Typically, there are four wire coils spaced at approximately equidistant intervals around the inner circumference wall 120 of the stationary magnet 118. However, there may be more than four wire coils as desired. Typically, the greater the number of wire coils, the greater the electric current.

At least a portion of each of the plurality of conductors 132 must be located between the rotating magnet 110 and the stationary magnet 118 to capture the induced electricity. Each of the first ends 138 of the plurality of conductors 132 are connected to the inner circumference wall 120 of the stationary magnet 118 at a plurality of corresponding conductor attachment points 138 by welding, soldering, and the like. Each of the plurality of conductors 132 then extend substantially perpendicularly upward towards the top of the housing 102. Each of the second ends 140 of the plurality of conductors 132 then connect together to terminate into a single wire, the electrical output 142. As the electrical output 142 exits the housing 102, the electrical output 142 is attached to the housing 102 at the top to support the conductor element 130 and the stationary magnet 118.

To use the apparatus 100 to produce electricity, the electrical input 108 is plugged in and powers the electrical motor turbine 104. The electrical motor turbine 104 rotates the driveshaft 106, thereby spinning the positively charged rotating magnet 110. As it spins, the rotating magnet 110 interacts with the surrounding negatively charged stationary magnet 118 to induce a magnetic current in the plurality of conductors 130 which are attached to the stationary magnet 118. The plurality of conductors 130 transmit the induced electricity to the electrical output 142 for external use.

Other variations are within the spirit of the present invention. Thus, while the invention is susceptible to various modifications and alternative constructions, a certain illustrated embodiment thereof is shown in the drawings and has been described above in detail. It should be understood, however, that there is no intention to limit the invention to the specific form or forms disclosed, but on the contrary, the intention is to cover all modifications, alternative constructions, and equivalents falling within the spirit and scope of the invention, as defined in the appended claims.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

Preferred embodiments of this invention are described herein. Variations of those preferred embodiments may become apparent to those of ordinary skill in the art upon reading the foregoing description. The inventor expects skilled artisans to employ such variations as appropriate, and the inventor intends for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. An apparatus for producing an electric current comprising:
a housing;
an electric turbine located within the housing, the electrical turbine comprising a driveshaft and an electrical input; and
a rotating magnet attached to the driveshaft, wherein the electric turbine rotates the driveshaft to spin the rotating magnet; and
a stationary magnet surrounding the rotating magnet; and
a conductor element attached to the stationary magnet and extending out of the housing, wherein an electric current is induced in the conductor element as the rotating magnet spins within the stationary magnet.

2. The apparatus of claim 1, wherein the rotating magnet is a cylindrical magnet.

3. The apparatus of claim 2, wherein the stationary magnet is a ring magnet.

4. The apparatus of claim 3, wherein a distance between a circumference of the cylindrical magnet and an inner circumference of the ring magnet is approximately between 20 and 30 percent of a diameter of the cylindrical magnet.

5. The apparatus of claim 4, wherein the rotating magnet is spun counterclockwise by the electric turbine.

6. The apparatus of claim 5, wherein the conductor element comprises a plurality of conductors in electrical communication with an electrical output.

7. An apparatus for producing an electric current comprising:
a housing;
an electric turbine located within the housing, the electrical turbine comprising a driveshaft and an electrical input; and
a positively charged cylindrical rotating magnet attached to the driveshaft, wherein the electric turbine rotates the driveshaft to spin the rotating magnet; and
a stationary negatively charged ring magnet surrounding the positively charged cylindrical rotating magnet; and
a conductor element attached to the stationary magnet and extending out of the housing, wherein an electric current is induced in the conductor element as the rotating magnet spins within the stationary magnet.

8. The apparatus of claim 7, wherein the conductor element comprises a plurality of conductors in electrical communication with an electrical output.

9. The apparatus of claim 8, wherein the plurality of conductors are spaced at approximately equidistant intervals around an inner circumference of the stationary negatively charged ring magnet.

10. The apparatus of claim 9, wherein at least a portion of the plurality of conductors are located between the rotating positively charged cylindrical magnet and the stationary negatively charged ring magnet

11. The apparatus of claim 10, wherein the plurality of conductors each comprise a wire coil.

12. The apparatus of claim 11, the conductor element further comprising an electrical output, wherein each of the wire coils terminate in the electrical output.

13. The apparatus of claim 12, wherein a distance between a circumference of the cylindrical magnet and an inner circumference of the ring magnet is approximately between 20 and 30 percent of a diameter of the cylindrical magnet.

14. An apparatus for producing an electric current comprising:
a housing;
an electric turbine located within the housing, the electrical turbine comprising a driveshaft and an electrical input; and
a rotating magnet attached to the driveshaft, wherein the electric turbine rotates the driveshaft to spin the rotating magnet; and
a stationary magnet surrounding the rotating magnet; and
a conductor element comprising a plurality of approximately equidistant conductors attached to the stationary magnet and an electrical output attached to and extending out of the housing, wherein at least a portion of the plurality of equidistant conductors are located between the rotating magnet and the stationary magnet, and wherein an electric current is induced in the conductor element as the rotating magnet spins within the stationary magnet.

15. The apparatus of claim 14, wherein the plurality of approximately equidistant conductors comprises four conductors.

16. The apparatus of claim 15, wherein each of the four conductors comprise a wire coil comprising a first end and a second end.

17. The apparatus of claim 16, wherein each of the first ends attach to an inner circumference of the stationary magnet, and the second ends terminate in the electrical output.

18. The apparatus of claim 17, wherein the rotating magnet is a positively charged cylindrical magnet and the stationary magnet is a negatively charged ring magnet.

19. The apparatus of claim 17, wherein the rotating magnet is a negatively charged cylindrical magnet and the stationary magnet is a positively charged ring magnet.

20. The apparatus of claim 19, wherein the rotating magnet is spun clockwise by the electric turbine.
